(19) United States
(12) Patent Application Publication
(10) Pub. No.: US 2009/0214386 A1
(43) Pub. Date: Aug. 27, 2009

(54) Coupling of conduits with melted and solidified plastic material

(76) Inventors: Bertram Beigel, Karlsruhe (DE); Jochen Mueller, Karlsruhe (DE)

Correspondence Address: Agilent Technologies;Legal Department DL 429, Intellectual Property Administration, P O Box 7599, Loveland, CO, 80537-0599, US

(21) Appl. No.: 11/989,061

(22) PCT Filed: Jul. 19, 2005
(86) PCT No.: PCT/EP2005/053486

§ 371 Date: Jan. 23, 2009

(51) Int. Cl. G01N 30/02; F16L 47/02; G05D 7/01

(52) U.S. Cl. 422/70; 285/21.1; 137/597

(57) ABSTRACT

A method of coupling at least two conduits for bringing them in communication. Each of the conduits is adapted for conducting a medium and has an outlet and an outer surface adjacent to the outlet. The outer surfaces and a solid plastic material are at least partly inserted into an aperture of a coupling element. The plastic material is plastified and/or melted at least partly. The plastic material is solidified for sealing and fixing the conduits within the aperture of the coupling element.

### BACKGROUND ART

The present invention relates to coupling of conduits.

Couplings are used for allowing conduits adapted for conducting a medium to communicate. Known are, for example, light guides or fluid conduits for conducting light or a fluid, for example a liquid. A capillary, for example, can serve as a fluid conduit and as a light guide. Flow cells, for example, for analyzing a fluid can comprise a fluid conduit and a light guide. Flow cells can comprise different conduits communicating via one or more connections.

U.S. Pat. No. 6,526,188 B2 and the US 2001/0010747 show a modular flow cell having a high optical throughput, a long optical path length and a small cross-section. The modular flow cell configuration includes remote ports or connections for liquid and light input, and liquid and light output.

U.S. Pat. No. 5,444,807 shows a flow-through cell for use in the measurement of chemical properties of small volumes of fluid containing dissolved analytes.

U.S. Pat. No. 5,608,517 discloses a coated flow cell and a method for making the coated flow cell. The flow cell comprises a flow passage, wherein light directed into the flow cell is internally reflected down the flow passage.

### DISCLOSURE

It is an object of the invention to provide an improved coupling of at least two conduits. The object is solved by the independent claims. Further embodiments are shown by the dependent claims.

According to embodiments of the present invention, a method of coupling at least two conduits for bringing them in communication is suggested. Each of the conduits is adapted for conducting a medium, for example, light and/or fluid and comprises an outlet and an outer surface adjacent to the outlet. The outer surfaces of the conduits are inserted at least partly into an aperture of a coupling element. Besides this, a solid plastic material is inserted into the aperture. Thereafter, the plastic material is heated at least partly for plastifying and/or melting the plastic material at least partly. Finally, the plastic material is solidified for example for sealing and fixing the conduits within the aperture of the coupling element. Further embodiments may comprise one or more of the following. Advantageously, the plastic material can be solidified very quickly by cooling. This enables a very short production time per piece. Besides this, the resulting coupling element is relative small and well usable for coupling fragile conduits.

Advantageously, the solid plastic material can be prefabricated, for example, by injection molding, extrusion molding, a turning process, or alike. The plastic material can be melted by heating at least partly the arrangement of the at least two conduits and the coupling element. Advantageously, a plurality of such couplings can be pre-mounted and then finished by heating them up concurrently, for example, in a curing oven. Besides this, the plastic material can be heated up by inducing a current into the coupling element, wherein the coupling element can comprise at least partly a conductive material. Advantageously, the couplings can be produced in a mass manufacturing process with comparable short manufacturing time per produced unit. As assumption, the common operational parameters, for example, the currency and the time of the heat treatment can be easily determined by a test series. The plastic material can be heated above the softening temperature and/or above the melting temperature so that the plastic material can realize a chemical bond with the surface of a suited material of the coupling element and/or the conduits. For this purpose, the conduits can but do not have to comprise a metal coat. The component parts can be coated with a suited material. Such a chemical bond can be realized, for example, between polyetheretherketone (PEEK) and metal, for example, chromium. The plastic material can be heated to a temperature significantly above the melting point. Consequently, the viscosity of the plastic material can be reduced to a minimum.

The plastic material can be disposed exactly on and along an inner surface of the aperture and outer surfaces of the at least two conduits, wherein the inner surface is facing the outer surfaces. Advantageously, tolerances can be adjusted. This makes a cheaper production of the component parts of the coupling possible. Advantageously, preformed parts of the plastic material can be assembled between the surfaces. The preformed parts can be adapted for fitting in a gap between the surfaces. Advantageously, the preformed parts can comprise a low exactness. Due to the thermal expansion and reduced viscosity during the step of heating for plastifying and/or melting, the plastic material can be disposed especially exactly on and along the surfaces. The material can creep and/or flow into small gaps. Besides this, the preassembled construction can be unstressed at least partly by the step of plastifying and/or melting the plastic material. Any stress occurring with other methods, for example, soldering or brazing can be avoided. Furthermore, the sealing forces can be distributed homogenous to the surfaces of the sensitive parts. Besides this, a self-centering effect of the outer surfaces of the conduits within the aperture is possible.

In embodiments, the plastic material can also be an integral part of the conduits, for example at least a partly coating on the conduits.

Besides this, the plastic material can be melted by running a hot fluid through the conduits. By this, the plastic material can be melted partly at the interfacial area between the outer surfaces of the conduits and the inner surface of the aperture.

Advantageously, the plastic material expands while heating and shrinks while cooling down. The plastic material can be a high performance plastic material, such as polyetheretherketone (PEEK), fluoropolymers for example perfluoroamines (PFA) or fluorinated ethylen-propylen copolymer (FEP), duroplastic material for example Polyimide, compounds for example metal or ceramic filled PEEK. The increased volume of the plastic material leads to an increased pressure within the interfacial area or better the gap between the outer surfaces of the conduits and the inner surface of the aperture. The increased pressure is favorable for enabling the chemical bond. Dependent on the detention time of heating for plastifying and/or melting the plastic material, it can penetrate the surface structure. By this, the plastic material can be bounded between the outer surfaces of the conduits and the inner surface of the aperture. A rough or porous surface improves this effect. During solidifying, the plastic material will be tensed in the surface structure of the inner surface of the aperture. The tensing effect can be improved in a design by which the surface roughness of the material of the inner surface of the aperture is greater than the absolute measurement of the shrinkage of the plastic material. Besides this, the plastic material shrinks on the outer surfaces of the conduits. These effects enable a leak-proof connection of the conduits for pressures, for example, up to 300 bar or higher, via the aperture. Besides this, PEEK is very durable against strong solvents, for example, used for liquid chromatography or high performance liquid chromatography (HPLC) processes and does not cold flowing significantly.

Embodiments may comprise one or more of the following. The aperture comprises at least two openings, wherein one of the outer surfaces is inserted into a first opening of the aperture and one of the outer surfaces is inserted into a second opening of the aperture. By this, the outlets adjacent to the outer surfaces are both inserted into the aperture and facing each other. The inner surface of the aperture can be realized as a cylindrically inner surface of a bore, for example, a stepped bore. Advantageously, the diameter of the bore can be lower in the middle of the bore. The step inside the bore of the aperture can realize a limit stop for the conduits and the plastic material inserted into the aperture. After plastifying or rather melting and cooling down the plastic material, the outlets of the conduits communicate, for example, via a span of the inner surface of the bore of the aperture.

Embodiments may comprise one or more of the following. For connecting a light guide with an optical outlet and a fluid conduit with a fluid outlet, the optical outlet of the light guide can be inserted into the fluid outlet of the fluid conduit. The inner dimension of the fluid conduit has to be smaller than the outer dimension of the light guide. Both conduits can be inserted, fixed, and sealed within the aperture. The inner surface of the aperture is adapted to the different dimensions of the outer surfaces of the light guide and the fluid conduit.

According to further embodiments of the present invention, a coupling for bringing at least two conduits in communication is suggested. The coupling element comprises an aperture adapted for receiving a plastic material and at least partly outer surfaces of the at least two conduits. Embodiments may comprise one or more of the following. Advantageously, for sealing and fixing the conduits to an inner surface of the aperture of the coupling element, the plastic material was at least partly melted and thereafter solidified. The outer surfaces are circumferential surfaces surrounded with the plastic material. The material is disposed on and along the outer surfaces and the inner surface of the coupling element, wherein the inner surface faces the outer surfaces.

Embodiments may comprise one or more of the following. The at least one inner surface can comprise an undercut surrounded by the plastic material. Advantageously, the plastic material can additionally shrink on a circumferential surface of the undercut being part of the inner surface of the aperture. By this, the sealing can be improved. The shrinkage of the plastic material can be used additionally for sealing the inner surface of the aperture against the plastic material and consequently against the conduit surrounded also by the plastic material and inserted into the inner surface.

Embodiments may comprise one or more of the following. Advantageously, for coupling more than two conduits, the aperture can comprise a plurality of branches comprising the at least one inner surface. The branches are fluidically in communication with each other. Consequently, the plurality of conduits communicates via the branches of the aperture. Each of the conduits comprises an outlet inserted into one branch of the aperture. Possibly, one of the conduits comprises an optical outlet and another one a fluid outlet, for example, a capillary and a light guide, wherein the outlets are inserted into the aperture. For this purpose, standardized components can be used, for example, quartz capillaries, fibers, and/or photonic crystal fibers comprising entrapped air. Additionally, the optical outlet is inserted into the inner tube of the capillary for irradiating the fluid within the capillary. Advantageously, this can be used for realizing a flow cell.

According to further embodiments of the present invention, such a flow cell comprising at least one of said couplings is suggested. The light path of the flow cell can be easily realized by the light guide inserted into the capillary via the coupling. Besides this, the coupling can bring a supplying conduit in communication with the capillary. The flow cell can comprise two couplings each coupled to the light path and to the supplying conduit. By this, the flow cell can be supplied with a fluid, for example liquid, sample and drained via an inlet, a first coupling, the capillary, a second coupling, and an outlet of the supplying conduit. The light path of the flow cell leads through the sample via a light inlet of the light path, a first light guide, via the first coupling, the capillary, the second coupling, and a second light guide. For protecting the conduits, the flow cell can comprise a housing. Advantageously, the housing can comprise a supporting plate adapted for receiving the components of the flow cell and an according cover plate. The supporting plate and the cover plate surround and fix the couplings and the conduits of the flow cell. The design of the housing can compensate any thermal expansion of the different components of the flow cell and therefore magnify the operating temperature range.

According to further embodiments of the present invention, a fluid separation system with a fluid delivery system, a separation device, and a flow cell is suggested.

### BRIEF DESCRIPTION OF DRAWINGS

Other objects and many of the attendant advantages of embodiments of the present invention will be readily appreciated and become better understood by reference to the following more detailed description of embodiments in connection with the accompanied drawings. Features that are substantially or functionally equal or similar will be referred to by the same reference signs.

FIG. 1 shows a three-dimensional top front side view of a flow cell with a light conduit, a fluid conduit, and a housing,

FIG. 2 shows the flow cell in the view of FIG. 1, but in an exploded view,

FIG. 3 shows a three-dimensional top view of the conduits of the flow cell of FIG. 1 within a supporting plate of the housing without a cover part of the housing,

FIG. 4 shows a detailed view of a coupling element of the flow cell as shown in FIG. 3,

FIG. 5 shows a three-dimensional inner view of a cover of the housing of the flow cell,

FIG. 6 shows a three-dimensional view of the conduits of the flow cell as shown in the FIG. 1 to 4,

FIG. 7 shows a partly longitudinal view of the coupling element of FIG. 4 comprising a plastic material for fixing and sealing conduits within the coupling element, and

FIG. 8 shows a partly longitudinal view of a coupling element with an undercut surrounded by the plastic material and a cover element for encapsulating the plastic material.

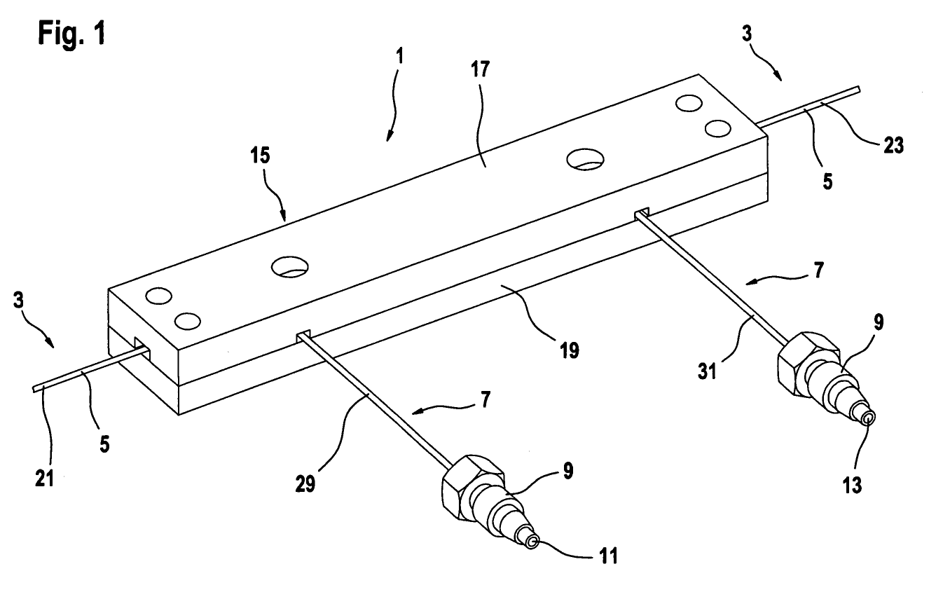

FIG. 1 shows a three-dimensional top front side view of a flow cell 1 with a light conduit 3 comprising a light guide 5 and a fluid conduit 7. The fluid conduit 7 of the flow cell 1 is coupled with two connecting pieces 9 realizing an inlet 11 and an outlet 13 for supplying and draining the flow cell 1 with a fluid, for example, with a liquid comprising a sample to be analyzed within the flow cell 1. The light conduit 3 is adapted for irradiating the sample flowing within the fluid conduit 7. Besides this, the light conduit 3 is adapted for guiding the light through the liquid within the fluid conduit 7 and out of the flow cell 1. Said light can be guided to a not shown light detector for detecting components within the sample.

The flow cell 1 comprises a housing 15 with a top cover 17 and a supporting plate 19. The housing 15 is adapted for receiving, positioning, and fixing the components within the flow cell 1 and facilitates the mounting. Besides this, the housing 15 surrounds the sensitive parts of the flow cell 1, consequently can protect them. Furthermore, before closing the top cover 17, the mounting process of the flow cell 1 can be visually checked.

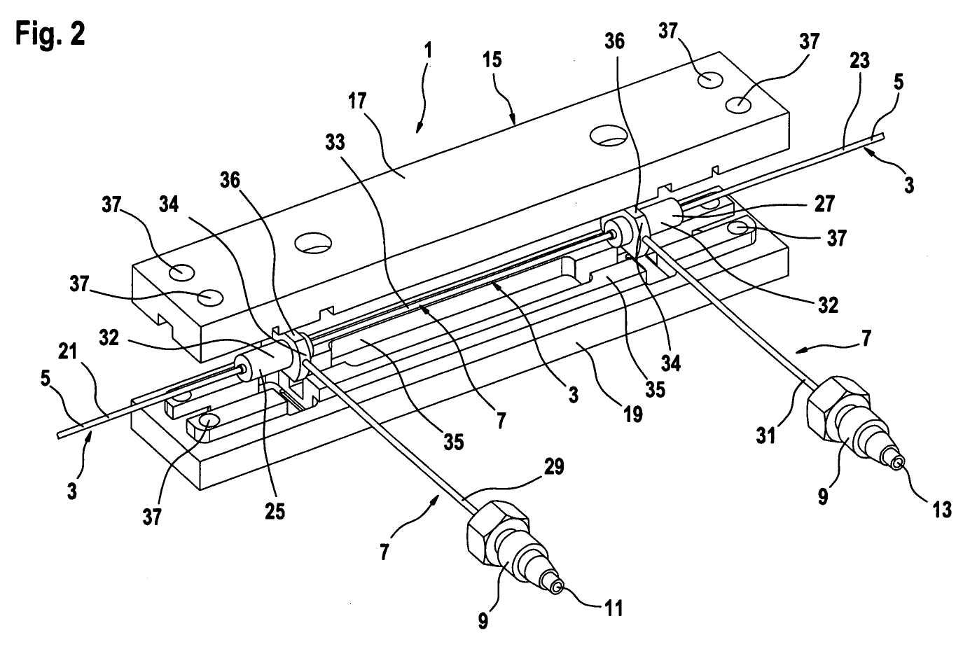

FIG. 2 shows the flow cell 1 as shown in FIG. 1, but in a three-dimensional exploded view. Visible is the complete light conduit 3, and the complete fluid conduit 7. A three-dimensional view of the conduits 3 and 7 without the housing 15 is shown in FIG. 6.

Referring to the FIGS. 2 and 6, the conduits 3 and 7 of the flow cell 1 are described more in detail. The light conduit 3 comprises a first fiber 21 and a second fiber 23 comprising a not shown light inlet and a not shown light outlet for the flow cell 1. The fibers 21 and 23 realize the light guide 5 of the light conduit 3. The first fiber 21 is coupled to a first coupling element 25 and the second fiber 23 is coupled to a second coupling element 27. Besides this, the first coupling element 25 is coupled to an inlet capillary 29 and the second coupling element 27 is coupled to an outlet capillary 31. Furthermore, both coupling elements 25 and 27 are coupled to an analysis capillary 33 being part of the light conduit 3 and the fluid conduit 7. The fluid conducted within the analyses capillary 33 can be irradiated by the first fiber 21 being consequently in communication with the analysis capillary 33 via the first coupling element 25. The analysis capillary 33 is fluidically in communication with the inlet 11 via the connecting piece 9, the inlet capillary 29 and the first coupling element 25. The other end of the analysis capillary 33 is fluidically in communication with the outlet 13 via the second coupling element 27, the outlet capillary 31 and the connecting piece 9.

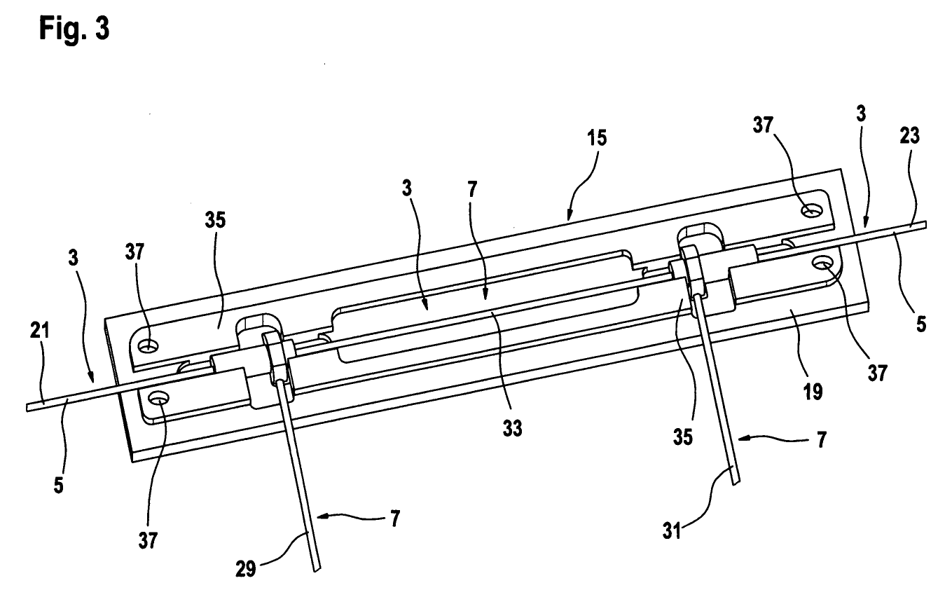

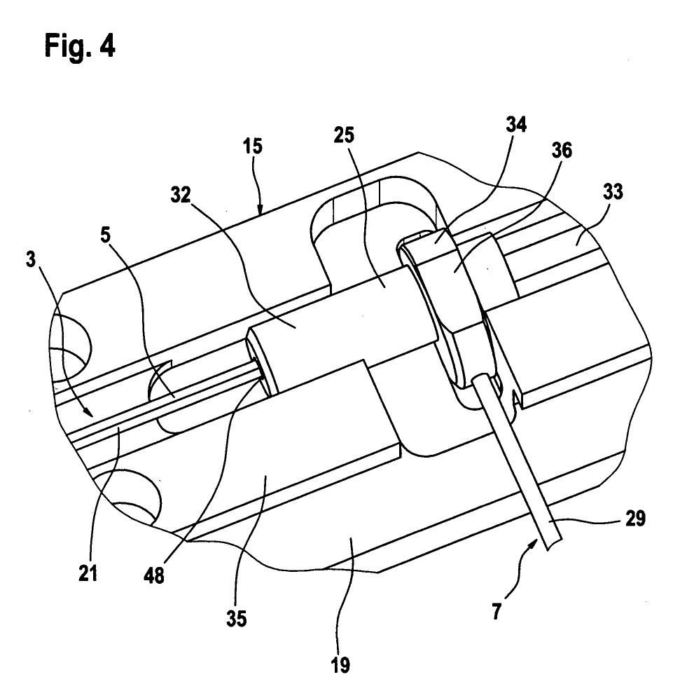

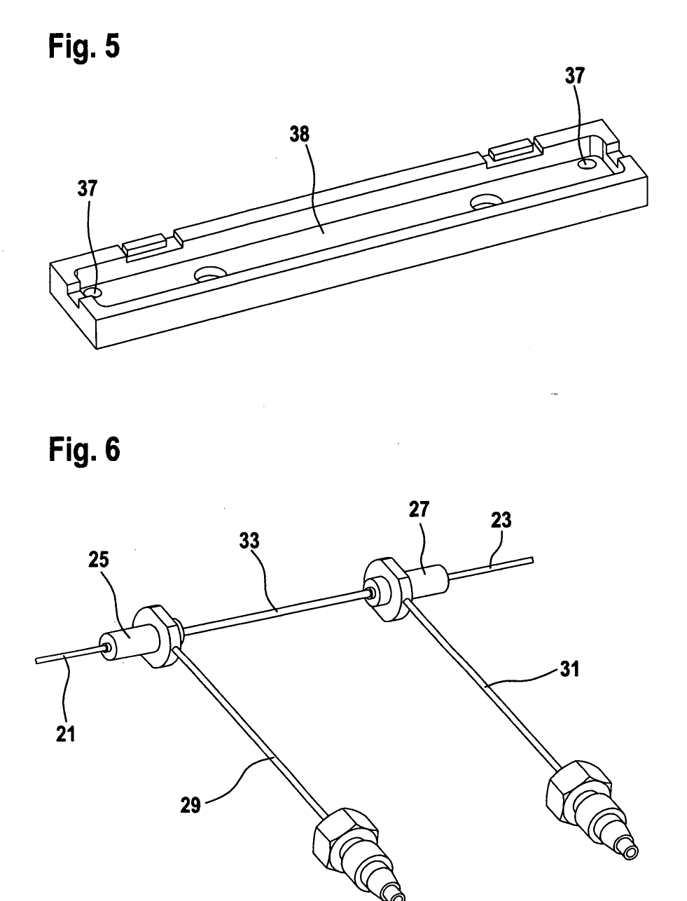

FIG. 3 shows a three-dimensional top view of the flow cell of FIG. 1 within the supporting plate 19 of the housing 15. The top cover 17 of the housing 15 is not shown in FIG. 3. FIG. 4 shows a detailed view of the coupling element 27 of the flow cell 1 as shown in FIG. 3. Referring to the FIGS. 2, 3, and 4, the functional elements of the supporting plate 19 are described in detail. The supporting plate 19 of the housing 15 comprises receiving elements 35 adapted for receiving the different components of the flow cell 1, for example, the different conduits 3 and 7 including the coupling elements 25 and 27. The shape of the receiving elements 35 is adapted for receiving the components of the flow cell 1 in a form and/or force fitting manner. In other words, the shape of the receiving elements 35 is adapted to the outer shapes of the components covered by the housing 15.

The coupling element 25 (as shown in FIG. 4 in detail) comprises a stepped cylindrically body 32 adapted for supporting and/or receiving the analysis capillary 33 and the fiber 21. The body 32 comprises a circumferential step 34 with truncations 36. The truncations 36 can be opposed to each other and adapted for fixing the coupling element between the top cover 17 and the supporting plate 19 of the housing 15. The coupling element 27 can be constrained between the top cover 17 and the supporting plate 19 of the housing 15 via the truncations 36 of the cylindrically step 34. The step 34 is adapted for supporting the inlet capillary 29

As shown in FIGS. 1 and 2, the housing 15 comprises the top cover 17. The top cover 17 is adapted to the outer shapes of the receiving elements 35 and the principally shape of the supporting plate 19. The receiving elements 35 match into an according recess 38 of the top cover 17. The top cover 17 can be fixed with the supporting plate 19 in a form and/or form fitting manner. Besides this, the top cover 17 and the supporting plate 19 can additionally fixed with each other via bores 37 adapted for receiving according fixing elements, such as screws, rivets, or alike.

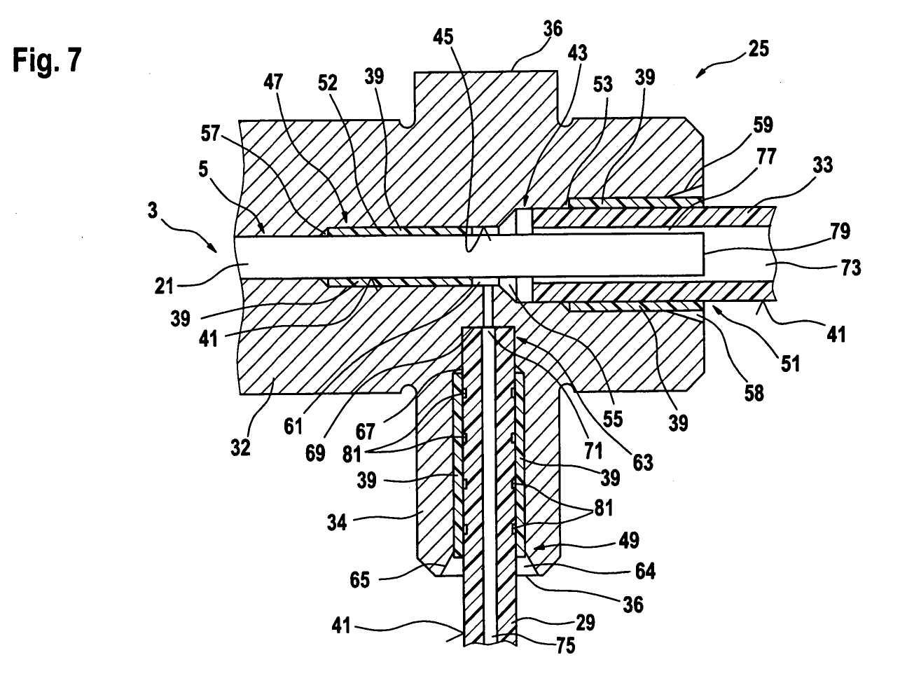

FIG. 7 shows a partly longitudinal view of the coupling element 25 of the flow cell 1. The coupling element 25 comprises a plastic material 39 adapted for fixing and sealing the conduit 3 and 7 of the flow cell 1 within the coupling element 25.

The fiber 21 of the light guide 5 of the light conduit 3 comprises an outer surface 41. The outer surface 41 is at least partly circumferential surrounded by the plastic material 39. The coupling element 25 comprises an aperture 43 comprising an inner surface 45. The aperture 43 of the coupling element 25 comprises a first branch 47 a second branch 49 and a third branch 51. The first branch 47 of the aperture 43 is adapted to the shape of the outer surface 41 of the fiber 21 and comprises a first opening 48 (not shown in FIG. 7). Consequently, the fiber 21 can be inserted into the first branch 47 of the aperture 43 of the coupling element 25. Besides this, the plastic material 39 can be inserted also into the first branch 47.

In the embodiment as shown in FIG. 7, the fiber 21 can be inserted through the first branch 47 into the aperture 43 and the plastic material 39 can be inserted through the third branch 51 or more precisely through a third opening 58 of the third branch 51. The inner surface 45 of the aperture 43 of the third branch 51 has a greater size as the diameter of the inner surface 45 of the first branch 47. The first branch 47 and the third branch 51 are coupled with each other and can be realized as a stepped through bore 52 with three steps 53 to 57. The first step 53 of the inner surface 45 of the third branch 51 reduces the inner diameter of the bore 52 down to the dimension of the outer diameter of the analysis capillary 33.

In the span with the greatest diameter before the first step 53, the aperture 43 of the coupling element 25 is adapted for receiving the analysis capillary 33 surrounded by the plastic material 39. The first step 53 can realize a limit stop for the plastic material 39 inserted into the aperture 33. At the second step 55 of the stepped bore 52 of the aperture 43, the diameter is reduced to the dimension of the outer diameter of the fiber 21 surrounded also by the plastic material 39. The third step 57 can realize a limit stop for the plastic material 39 surrounding the fiber 21. Consequently, the components of the coupling element 25 can be inserted in the following order into the stepped bore of the aperture 43: In a first step, the fiber 21 and the plastic material 39 surrounding the fiber 21 has to be inserted into the stepped bore 52 of the aperture 43. For avoiding any dead volume, the step 55 can comprise a flank adapted to the shape of the end of the analysis capillary 33. Consequently, the end of the analysis capillary 33 can be installed flush with the flank of the step 55 and bear against the flank of the step 55. The flank of the step 55 can be perpendicular to the longitudinal direction of the inner surface 45 of the aperture 43.

For example, firstly, the plastic material 39 can be inserted—in direction of FIG. 7—from the right hand side into the third branch of the aperture 43 until it stops at the limit stop realized by the third step 57. In a next step, for example, the fiber 21 can be inserted—in direction of FIG. 7—from the left hand side into the first branch 47 of the aperture 43 of the coupling element 45.

In a next step, the plastic material 39 surrounding the analysis capillary 33 can be inserted into the stepped bore 52 of the aperture 43 until the plastic material 39 is limited by limit stop realized by the first step 53 of the aperture 43 of the coupling element 25. Finally, the analysis capillary 33 can be inserted into the third branch 51 until it stops at the second step 55 of the stepped bore 52.

For simplifying the steps of inserting the components into the aperture 43, the stepped bore 52 or the third opening 58 can comprise a chamfer 59. The span of the stepped bore 52 of the aperture 43 between the third step 57 the second step 55 is not filled completely with the plastic material 39. Consequently, a gap 61 remains between the outer surface of the fiber 21 and the inner surface 45 of the aperture 43. At the span of the gap 61, a stepped supplying bore 63 leads into the through bore 52 of the aperture 43. The stepped supplying bore 63 or a second opening 64 of the second branch 49 of the aperture 43 can also comprise a chamfer 65. Besides this, the stepped supplying bore 63 comprises a first step 67 and a second step 69.

The inlet capillary 29 is also partly surrounded by the plastic material 39 and can be inserted into the stepped supplying bore 63 as follows. In a first step, the plastic material 39 can be inserted into stepped supplying bore 63 of the aperture 43 until the plastic material 39 is limited by a limit stop realized by the first step 67 of the stepped supplying bore 63. In a second step, the inlet capillary 29 can be inserted into the stepped supplying bore 63 until it is limited at a limit stop realized by the second step 69. In a second step, the inlet capillary 29 can be inserted into the stepped bore 63 until it is limited by a limit stop realized by the second step 69. Possibly, the capillary 29 can be inserted concurrently together with the plastic material 39. The span of the stepped supplying bore 63—in direction for FIG. 7—above the second step 69 is coupled fluidically to an outlet 71 of the inlet capillary 29 and to the gap 61 within the stepped through bore 52. The outlet 71 is adjacent to an outer surface 41 of the inlet capillary 29.

For supplying an inner tube 73 of the analysis capillary 33 with a liquid, an inner tube 75 of the inlet capillary 29 is fluidically in communication with the inner tube 73 of the analysis capillary 33. A fluid or a liquid can be conducted from the Inner tube 75 of the supplying capillary 29 to the inner tube 73 of the analysis capillary 33 via the inner surface 45 of the aperture 43 of the coupling element 25, in particular via the stepped supplying bore 63, the gap 61 within the through bore 52 between the fiber 21 and the inner surface 45, and a gap 77 between the fiber 21 and the inner tube 73 of the analysis capillary 33. The fiber 21 is inserted into the inner tube 33 of the analysis capillary 33. The outer diameter of the fiber 21 and the inner diameter of the inner tube 73 of the analysis capillary 33 are dimensioned so that the gap 77 is large enough for conducting a fluid into the analysis capillary 33. Besides this, light can be irradiated into a fluid within the inner tube 73 of the analysis capillary 33 via the fiber 21 comprising an optical outlet 79 adjacent to the outer surface of the fiber 21.

The analysis capillary 33 is in communication with the fiber 21 via the medium light. Besides this, the inner tube 73 of the analysis capillary 33 is fluidically in communication with the inlet capillary 29. The coupling element 25 brings the light conduit 3 and the light conduit 7 in communication with each other.

For sealing and fixing the fiber 21, the inlet capillary 29, and the analysis capillary 33 within the aperture 43 of the coupling element 25 or rather to the inner surface 45 of the aperture 43, the plastic material 39 can be melted and solidified. By this, the plastic material 39 can realize a chemical bond with and/or can be tensed to the surface structure of the outer and inner surfaces of the components of the coupling element 25. The shrinkage of the plastic material in longitudinal direction supports this bounding or keying. To plastify and/or melt the plastic material 39, the complete coupling element 25 can be heated up to a temperature higher than the softening and/or melting temperature of the plastic material 39. Another method of plastifying and/or melting the plastic material 39 can be realized by inducing a current in the coupling element 25. For this purpose, the coupling element 25 can comprise a conductive material, for example, consists or of metal and/or can be coated with a conductive layer. For improving the compound of the plastic material and the surfaces, the surfaces can be roughened. In other embodiments, the surface can comprise a structure, for example, circumferential recesses 81. As shown in FIG. 7, the inlet capillary 29 comprises exemplarily four recesses 81. Advantageously, the thickness of the plastic material 39 can be dimensioned so that capillary forces between the surfaces keep the melted plastic material 39 within the aperture 43 of the coupling element and so that the total shrinkage is smaller than the surface roughness of the inner surface 45 of the aperture 43.

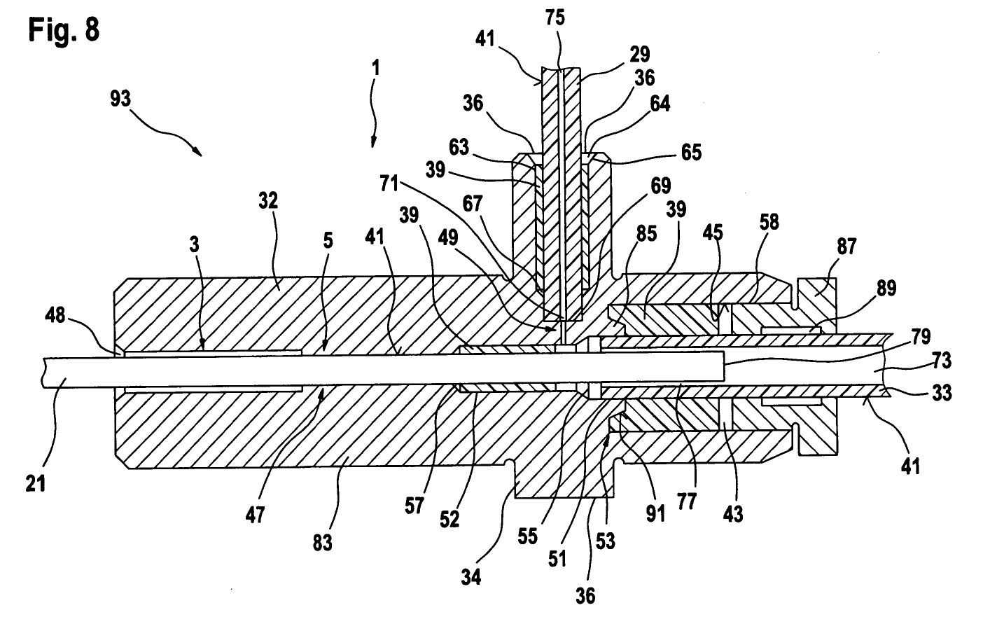

FIG. 8 shows a partly longitudinal view of a coupling element 83 with an undercut 85 surrounded with the plastic material 39. The undercut is within the aperture 43 and part of the inner surface 45. The first step 53 of the through bore 52 comprises the undercut 85. Besides this, the coupling element 83 comprises an additional cover element for encapsulating the plastic material 39 within the aperture 43 of the cover element 87. In this embodiment, the thickness of the plastic material 39 surrounding the analysis capillary 33 is dimensioned so that the plastified and/or melted plastic material 39 would flow out of the aperture 43 of the coupling element 83 during the step of plastifying and/or melting. To avoid this, the cover element 87 can be inserted additionally into the third opening 58 of the aperture 43 of the coupling element 83 for enclosing or encapsulating the plastic material 39 within the aperture 43. The cover element 87 comprises a bore 89 adapted for receiving the analysis capillary 33. The cover element 87 comprises a stepped cylindrically outer shape, wherein the cylinder with the smaller diameter can be adapted for realizing a press fit with the inner surface 45 of the aperture 43.

Additionally, the bore 89 and/or the cover element 87 can comprise a sealing material, for example silicone, rubber, Teflon®, or alike. During the step of heating the plastic material 39, the pressure within the aperture is increased, so that the plastic material 39 can penetrate the surface structure of the inner surface 45 of the aperture 43 and an outer surface 41 of the analyses capillary 33. During the step of solidifying, the plastic material 39 shrinks on the outer surface of the analysis capillary 33. Besides this, the plastic material shrinks also on an outer surface 91 of the undercut 85 of the inner surface 45 of the aperture 43. The outer surface 91 is part of the inner surface 45 of the aperture 43.

Advantageously, the plastic material 39 realizes a sealing contact with the outer surface 91 of the undercut 85 and the outer surface of the analysis capillary 33. Because of the shrinking forces applied to the surface 91 of the undercut 85 and the outer surface of the analysis capillary 33, it can be avoided, that strong solvents, possibly destroying the chemical compound, between the plastic material and the outer surface 91 of the undercut 85 and the outer surface of the analysis capillary 33.

The plastic material 39 can comprise a chemically inert polymer material, for example polyetheretherketon (PEEK), fluoropolymers for example perfluoroamines (PFA) or fluorinated ethylen-propylen copolymer (FEP), duroplastic material for example Polyimide, compounds for example metal or ceramic filled PEEK. .

The flow cell 1 can be part of a fluid separation system 93 comprising a fluid delivery system, a separation device adapted for separating components delivered by the fluid delivery system. The flow cell 1 can be used for detecting the separated components within the fluid. The fluid separation system 93 can comprise, for example, a chromatographic system (LC), a high performance liquid chromatographic (HPLC) system, an HPLC arrangement comprising a chip and an mass spectrograph (MS), a high throughput LC/MS system, a purification system, micro fraction collection/spotting system, a system adapted for identifying proteins, a system comprising a GPC/SEC column, a nanoflow LC system, and/or a multidimensional LC system adapted for separation of protein digests.

The flow cell 1 can be adapted for analyzing liquid. More specifically, the flow cell 1 can be adapted for executing at least one microfluidic process, for example a liquid chromatographic process, for example a high performance liquid chromatographic process (HPLC). Therefore, the flow cell 1 can be coupled to a liquid delivery system, in particular to a pump, and/or to a power source. For analyzing liquid or rather one or more components within the liquid, the flow cell 1 can comprise a detection area, such as an optical detection area and/or an electrical detection area being arranged close to a flow path within the flow cell 1. Besides this, the flow cell 1 can be a component part of a laboratory arrangement.

It is to be understood, that this invention is not limited to the particular component parts of the devices described or to process steps of the methods described as such devices and methods may vary. It is also to be understood, that different features as described in different embodiments, for example illustrated with different Fig., may be combined to new embodiments. It is finally to be understood, that the terminology used herein is for the purposes of describing particular embodiments only and it is not intended to be limiting. It must be noted, that as used in the specification and the appended claims, the singular forms of “a”, “an”, and “the” include plural referents until the context clearly dictates otherwise. Thus, for example, the reference to “a coupling element”, “a capillary”, or “an inner surface” includes two or more such functional elements.

1-30. (canceled)

31. A method of coupling at least two conduits for bringing them in communication, wherein each of the conduits is adapted for conducting a medium and comprises an outlet and an outer surface adjacent to the outlet, and at least one of the conduits comprises a light guide adapted for conducting and irradiating a fluid with light and at least one of the conduits is a fluid conduit adapted for conducting a fluid,
the method comprising:
inserting the outer surfaces at least partly and a solid plastic material into an aperture of a coupling element,
heating the plastic material at least partly for at least one of: plastifying, melting,
solidifying the plastic material for sealing and fixing the conduits within the aperture of the coupling element.

32. The method of claim 31, comprising:
inserting and disposing the plastic material on and along an inner surface of the aperture and the outer surfaces of the at least two conduits, wherein the inner surface is facing the outer surfaces.

33. The method of claim 31, comprising at least one of:
plastifying the plastic material by heating at least partly the arrangement of the at least two conduits and the coupling element;
melting the plastic material by heating at least partly the arrangement of the at least two conduits and the coupling element;
inserting one of the outer surfaces into a first opening of the aperture and one of the outer surfaces into a second opening of the aperture;

34. The method of claim 31, comprising at least one of:
heating the plastic material by inducing a current into the coupling element, wherein the coupling element comprises at least partly a conductive material;
heating the plastic material by running a hot fluid through the conduits;
connecting the outlets via the aperture for bringing them in communication,
inserting one of the outer surfaces with integral coating into a first opening of the aperture and one of the outer surfaces with integral coating into a second opening of the aperture.

35. The method of claim 31, wherein the light guide comprises an optical outlet and the fluid conduit comprises an inner tube, comprising:
inserting the optical outlet of the light guide into the inner tube of a capillary.

36. A coupling for bringing at least two conduits in communication, comprising:
a coupling element with an aperture, and
a plastic material or compound adapted for sealing and fixing the at least two conduits within the aperture,
wherein each conduit comprises an outer surface and is adapted for conducting a medium,
the aperture is adapted for receiving the plastic material and at least partly the outer surfaces of the conduits,
the plastic material was heated for at least one of: at least partly plastifying, at least partly melting; and thereafter solidified, and
at least one of the conduits comprises a light guide adapted for conducting and irradiating a fluid with light and at least one of the conduits is a fluid conduit adapted for conducting a fluid.

37. The coupling of claim 36, wherein the aperture comprises at least one inner surface.

38. The coupling of claim 37, comprising at least one of:
the at least one inner surface comprises an undercut surrounded by the plastic material;
each outer surface faces one of the at least one inner surfaces of the aperture;
the heated and solidified plastic material is disposed on and along the outer surfaces of the at least two conduits and on of the at least one inner surfaces of the coupling element.

39. The coupling of claim 36, comprising at least one of:
the conduits each comprise an outlet adjacent to the according outer surface;
each outer surface is a circumferential surface surrounded with the plastic material;
the aperture is at least one of the following: an inner through bore, a stepped supplying bore, an opening, a breakthrough of the coupling element,
the aperture comprises a plurality of at least three branches placed in communication, wherein each branch is coupled with one conduit and the plastic material.

40. The coupling of claim 36, comprising at least one of:
the fluid is at least one of: a liquid, a solvent, a sample;
the outlet of the fluid conduit is a fluid outlet and the outlet of the light guide is an optical outlet;
the optical outlet of the light guide is inserted into the fluid outlet of the fluid conduit, wherein the fluid conduit preferably comprises a capillary.

41. The coupling of claim 36, wherein the plastic material comprises polyetheretherketone, fluoropolymers, in particular perfluoroamines or fluorinated ethylen-propylen copolymer, duroplastic material, in particular polyimide, compounds, in particular, metal or ceramic filled PEEK.

42. A flow cell for housing a fluid sample and for exposing the fluid sample to radiation for analysis, comprising at least one of the following:
at least one coupling of claim 36,
a capillary adapted for conducting the fluid sample,
a light path comprising the capillary, a first and a second light guide adapted for conducting the light into and out of the flow cell,
a supplying conduit adapted for conducting the fluid sample into and out of the capillary.

43. The flow cell of claim 42, comprising at least one of:
the flow cell comprises two of the couplings;
the couplings comprise each a plurality of communicating branches;
the couplings comprise each a first branch each coupled to one of the light guides, a third branch each coupled to one end of the analysis capillary, and each a second branch each coupled to a supporting capillary;
the flow cell comprises a housing for supporting and surrounding the capillary and the couplings.

44. A fluid separation system comprising
a fluid delivery system,
a separation device for separating components of the fluid delivered by the fluid delivery system, and
a flow cell of claim 42 for detecting the separated components within the fluid.

45. The fluid separation system of claim 44, wherein the fluid separation system comprises at least one of:
a chromatographic system,
a high performance liquid chromatographic system,
an HPLC arrangement comprising a chip and an mass spectrograph,
a high throughput LC/MS system,
a purification system,
micro fraction collection/spotting system,
a system adapted for identifying proteins,
a system comprising a GPC/SEC column,
a nanoflow LC system,
a multidimensional LC system adapted for separation of protein digests.
